(19) United States
(12) Patent Application Publication
(10) Pub. No.: US 2025/0095613 A1
(43) Pub. Date: Mar. 20, 2025

(54) KEY PAD FOR WIND INSTRUMENT

(71) Applicant: Kwang Ki KIM, Chuncheon-si (KR)

(72) Inventor: Kwang Ki KIM, Chuncheon-si (KR)

(21) Appl. No.: 18/960,891

(22) Filed: Nov. 26, 2024

Related U.S. Application Data
(63) Continuation of application No. PCT/KR2023/009148, filed on Jun. 29, 2023.

(30) Foreign Application Priority Data
Jul. 20, 2022 (KR) 10-2022-0089368

(51) Int. Cl. G10D 9/04; G10D 7/06

(52) U.S. Cl. CPC G10D 9/04; G10D 7/06

(57) ABSTRACT

The present invention relates to a pad structure that can improve the tone of a wind instrument and does not deform even after long-term use. More specifically, the present invention relates to a pad for opening and closing a tone hole of a wind instrument by adhering to an upper main part of a tone hole tube, including: a circular silicone pad adhering to the upper main part; a fixing pad for fixing the circular silicone pad to an inner side of a key; a reflector positioned between the circular silicone pad and the fixed pad; and an adhesive layer for bonding the fixing pad and the circular silicone pad.

### CROSS-REFERENCE TO RELATED APPLICATIONS

The present application is a Continuation of International Patent Application No. PCT/KR2023/009148, filed on Jun. 29, 2023, which is based upon and claims the benefit of priority to Korean Patent Application No. 10-2022-0089368 filed on Jul. 20, 2022. The disclosures of the above-listed applications are hereby incorporated by reference herein in their entirety.

### TECHNICAL FIELD

The present invention relates to a pad structure that can improve the tone of a wind instrument while maintaining its shape even after long-term use.

### BACKGROUND ART

In general, sound transmitted through wind instrument utilizes the vibration of air.

A number of cap holders are formed inside the wind instrument, a pad is attached to the inside of the cap holders, and by vibrating the pad, the wind instrument resonates and produces sound.

As mentioned above, music created through sound using the transmission of air is the art of sound, musical sounds and all sounds originate from the vibration of air, and the wind instrument is regulator that controls the flow of air and are tools that change the flow of air into musical sounds using effect of vibration.

In other words, performance music also utilizes the vibration phenomenon in the air, and performance is a physical phenomenon in which the vibration phenomenon using a musical instrument is heard through the auditory organ via the medium called air.

As mentioned above, the source of musical sound and performance is the vibration that is changed into sound and expressed through performance, the technology to control the vibration is the core principle of controlling musical tools and musical instruments.

Playing a musical instrument is changing vibrations into artistic sounds, expressing these vibrations as artistic sounds, and expressing emotions. Sound when strengthen the vibrations, results in better resonance, and using the resonance artistically is a great performance.

In order to improve the quality of live performance music in an analog state, it is essentially important to improve the performance of the instrument itself. For this reason, professional musicians prefer and choose to use expensive, famous instruments with good sound quality at concerts. A good instrument such as this is called a famous instrument. The good instrument refers to an instrument with good sound quality, good timbre, rich volume, and good aftertone and resonance. Furthermore, an instrument with good resonance is an instrument with regular vibration periodicity. In other words, an instrument with regular vibration periodicity and good vibration periodicity is referred to as a famous instrument.

FIG. 1 is a cross-sectional side view for explaining the key structure of a wind instrument.

As shown in FIG. 1, typically, there are an upper main part 1b of the tone hole tube 1 where the tone hole 1a is formed, and a pad 2 that is attached (or detached) from the upper main part 1b and closes the upper main part 1b. The pad 2 is opened or closed by the player's performance.

If the shape of the pad 2 or key 3 is deformed for various reasons, a space S is created between the upper main part 1b and the pad 2. If the vibration sound leaks through the space S, an incorrect sound is generated.

To produce the correct sound, the space(S) must be removed.

The conventional pad 2 structure made of leather and wool filling inevitably hardens over time, and it is not easy to remove the space S caused by this hardening phenomenon.

Accordingly, there is a need for research on a pad structure that prevents the space S from being created between the upper main part 1b and the pad 2 due to not being hardened for a long time.

### Prior Patent Document

Korean Patent Registration No. 10-2220038

### DISCLOSURE OF THE INVENTION

### Technical Problem

The present invention provides a pad for a wind instrument that does not harden even after a long period of time and can continuously produce correct sounds.

The present invention also provides a pad structure capable of enhancing the tone of a saxophone by maximizing the resonance effect caused by vibration.

The technical problems to be achieved in the present invention are not limited to the technical problems mentioned above, and other technical problems not mentioned will be clearly understood by a person having ordinary skill in the technical field to which the present invention belongs from the description below.

### Technical Solution

Embodiments of the present invention provide a pad for opening and closing a tone hole of a wind instrument by adhering to an upper main part of a tone hole tube, including: a circular silicone pad adhering to the upper main part; a fixing pad for fixing the circular silicone pad to an inner side of a key; a reflector positioned between the circular silicone pad and the fixed pad; and an adhesive layer for bonding the fixing pad and the circular silicone pad.

Here, the circular silicone pad is a disc of silicone rubber with a thickness of about 1.0 to 1.5 mm.

Here, the fixing pad is formed in a disc shape smaller than the diameter of the circular silicone pad.

### Advantageous Effects

The effects of a pad of saxophone according to the present invention are as follows.

According to at least one of the embodiments of the present invention, there is an advantage in that the pad for the wind instrument can be provided that does not harden even after a long period of time and can continuously produce a correct sound.

In addition, according to at least one of the embodiments of the present invention, there is an advantage in that the pad can be provided that can enhance the tone of the saxophone by maximizing a resonance effect due to vibration.

Further scope of applicability of the present invention will become apparent from the detailed description below. However, since various changes and modifications within the spirit and scope of the present invention will become apparent to those skilled in the art, it should be understood that the detailed description and specific embodiments, such as preferred embodiments of the present invention, are given by way of example only.

### BRIEF DESCRIPTION OF THE DRAWINGS

FIG. 1 shows a cross-sectional side view illustrating a key structure of a wind instrument.

FIG. 2 is a schematic perspective view of a saxophone, a type of wind instrument.

FIG. 3 shows a disassembled perspective view of a key structure of a wind instrument.

FIG. 4 is a cross-sectional view showing a structure of a typical pad 2.

FIG. 5 illustrates a disassembled perspective view of a pad 2 according to an embodiment of the present invention.

FIG. 6 illustrates a cross-sectional side view of a pad 2 according to an embodiment of the present invention.

FIG. 7 is an actual product photo of a pad 2 according to an embodiment of the present invention.

FIGS. 8A to 10C are drawings showing a frequency change of a saxophone when a conventional pad and a pad according to an embodiment of the present invention are applied.

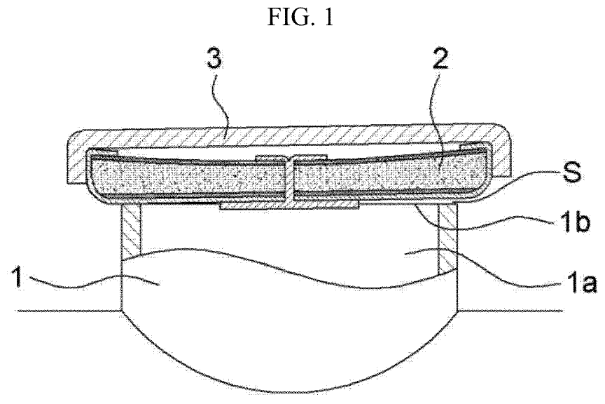

### MODE FOR CARRYING OUT THE INVENTION

Hereinafter, embodiments disclosed in this specification is described with reference to the accompanying drawings, and the same or corresponding components are given with the same drawing number regardless of reference number, and their duplicated description will be omitted. Furthermore, terms, such as a “module” ad a “unit”, are used for convenience of description, and they do not have different meanings or functions in themselves. Moreover, detailed descriptions related to well-known functions or configurations will be ruled out in order not to unnecessarily obscure subject matters of the present disclosure. However, this does not limit the present disclosure within specific embodiments and it should be understood that the present disclosure covers all the modifications, equivalents, and replacements within the idea and technical scope of the present disclosure.

It will be understood that although the terms of first and second are used herein to describe various elements, these elements should not be limited by these terms. Terms are only used to distinguish one component from other components.

It will also be understood that when an element is referred to as being “connected to” or “engaged with” another element, it can be directly connected to the other element, or intervening elements may also be present. It will also be understood that when an element is referred to as being ‘directly connected to’ another element, there is no intervening elements.

The terms of a singular form may include plural forms unless referred to the contrary.

The terms of a singular form may include plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components.

As described above, the space S between the tone hole and the pad of the wind instrument prevents a sound from being produced correctly. The reason why the space S is formed is that a material forming the pad hardens over time. Therefore, the present invention proposes to solve the above problem by using the pad with a material that does not harden.

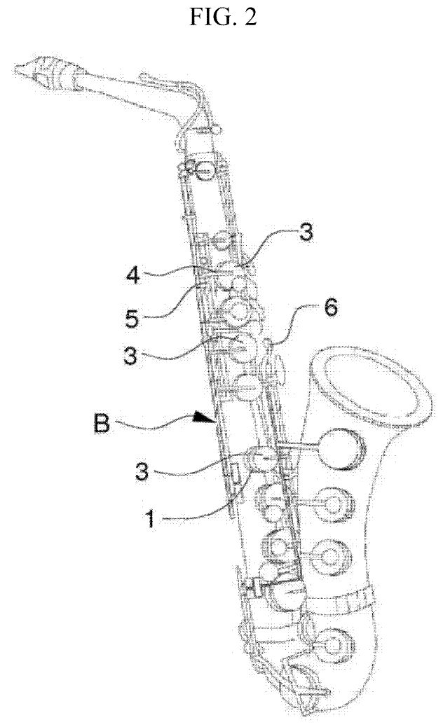

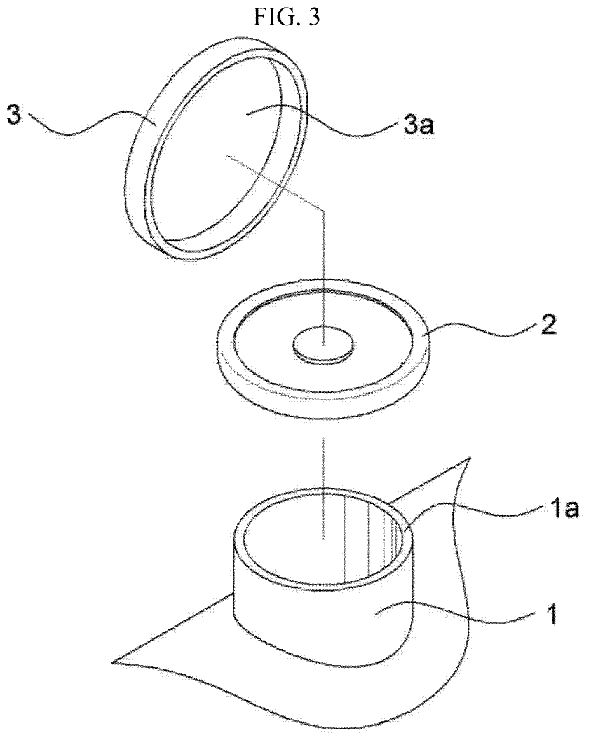

FIG. 2 is a schematic perspective view of a saxophone, a type of wind instrument, and FIG. 3 shows a disassembled perspective view of a key structure of a wind instrument.

Referring to FIG. 2, the saxophone has a plurality of tone hole tubes 1 in which tone holes 1a is formed, and a plurality of pads 2 that allow detachable closure of the tone holes 1a of the tone hole tubes 1.

Typically, a keypad (pad) for the tone hole has one side attached to the upper main part 1b of the tone hole tube 1 and the other side attached to the inner surface of the key 3 that detachably operates the pad 2.

One end of an arm 4 is attached to an outside of the key 3, the other end of the arm 4 is connected to a key rod 5, and a key button 6 is arranged.

As already explained in the background art, the space S is created between the upper main part 1b and the pad 2, the pad 2 is attached (or detached) to the upper main part 1b of the tone hole tube 1 and closes the upper main part 1b, so that the vibration sound leaks out through the space S, and thus the original sound is not generated.

The pad 2 includes a contact leather part 2a that contacts with the upper main part 1b of the tone hole tube 1, a filling material part 2b in which a plurality of thin papers are overlapped and arranged on the inner side of the contact leather part 2a, and an inner leather part 2c in which the edge of the contact leather part 2a is adhered to the inner self-edge of the filling material part 2b, and the keypad structure A for the tone hole of all wood wind instruments is such that an empty inner space S1 is formed between the inner leather part 2c of the pad 2 and the inner surface 3a of the key 3.

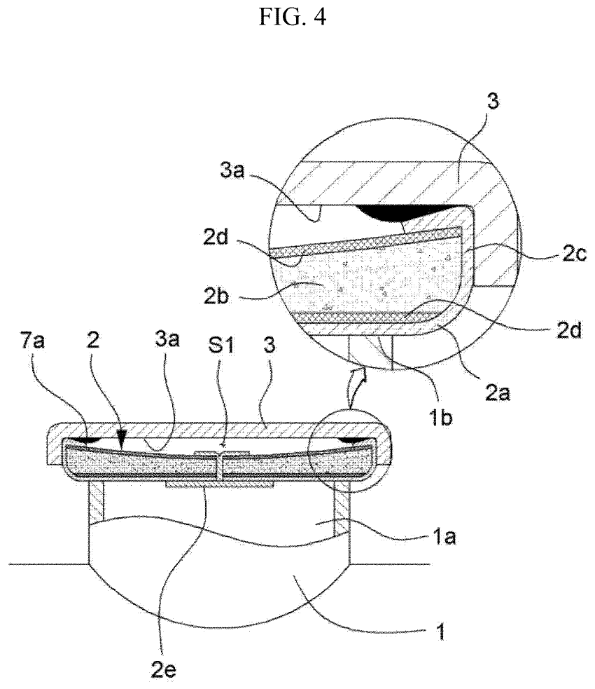

FIG. 4 is a cross-sectional view showing the structure of a typical pad 2.

The pad 2 includes a leather contact leather part 2a that contacts with the upper main part 1b of the tone hole tube 1, a filling material part 2b in which a plurality of thin papers are overlapped and arranged on the inner side of the contact leather part 2a, and an inner leather part 2c in which the edge of the contact leather part 2a is adhered to the inner self-edge of the filling material part 2b.

Looking at the structure of the pad 2 in more detail, the filling material part 2b of the pad 2 is composed of wool, synthetic fiber fabric, or thin paper aggregate, and thin paper 2d is attached to the upper and lower surfaces of the filling material part 2b, and the contact leather part 2a and the inner leather part 2c are adhered to the upper and lower surfaces of the filling material part 2b, and a fixing plate 2 penetrates and fixes the contact leather part 2a, the filling material part 2b, and the paper 2d in the middle of the pad 2.

The contact leather part 2a and the inner leather part 2c, as well as the filling part 2b, are all made of materials vulnerable to moisture. However, the pad 2 is always exposed to moisture due to the moisture contained in the breath of the player when the wind instrument is played. Since the pad 2 must always be exposed to moisture, but are made of materials vulnerable to moisture, there is a problem that the pad 2 is harden easily.

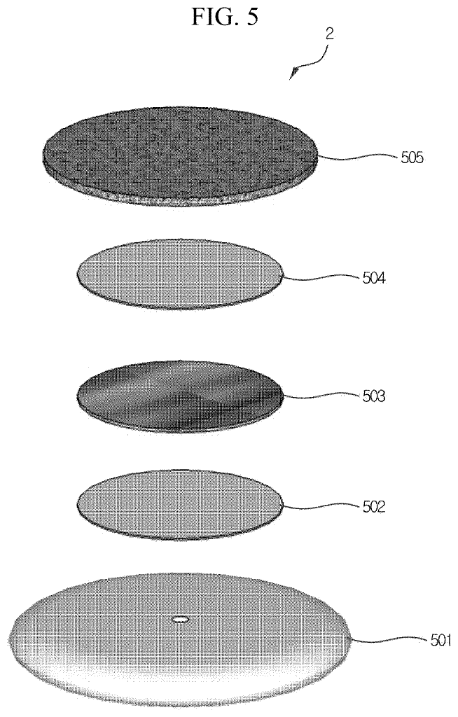

An embodiment of the present invention that improves the above problems will be described with reference to FIGS. 5 to 7.

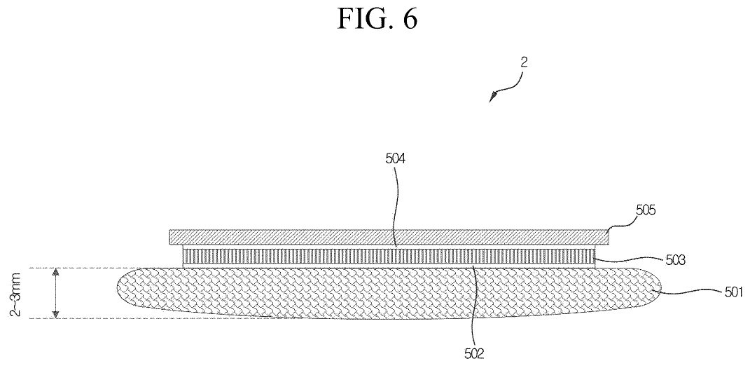

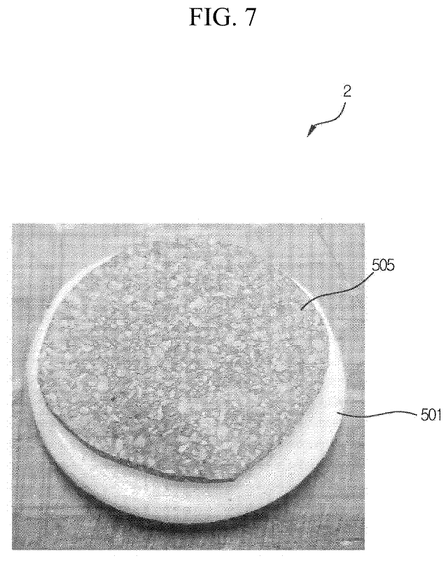

FIG. 5 shows a disassembled perspective view of the pad 2 according to an embodiment of the present invention. FIG. 6 shows a side cross-sectional view of the pad 2 according to an embodiment of the present invention. FIG. 7 is an actual product photo of the pad 2 according to an embodiment of the present invention.

According to an embodiment of the present invention, the pad adhesive to the upper main part of a tone hole tube to open and close the tone hole of the wind instrument may be configured to include a circular silicone pad 501 that closes to the upper main part; a fixing pad 505 for fixing the circular silicone pad to the inner surface of a key; and at least one adhesive layer 502, 504 for bonding the fixing pad and the circular silicone pad.

As described above, in order to eliminate the space S between the upper main part and the pad, a material that is not hardened but has a certain degree of elasticity is required. For this purpose, in an embodiment of the present invention, silicone is proposed as such a material. That is, the circular silicone pad 501 can seal the tone hole by directly or indirectly contacting the upper main part, and the sealing effect can be sufficiently expected due to the elasticity of the silicone material.

In particular, the thickness of the silicone pad 501 is about 2 to 3 mm, and the slope of the curve can be formed so that it becomes thinner from the center to the edge. This is to effectively seal the tone hole. If the silicone pad 501 has a flat disc shape, the tone hole cannot be effectively blocked, and the inside may float.

In particular, the hardness of the silicone material of the silicone pad 501 according to a preferred embodiment of the present invention is 20 to 40 in Shore hardness (Shore A). If shore hardness is less than 20, a feeling of inconsistency in playing is formed due to a sloppy feeling when the player presses the key. If shore hardness is more than 40, the silicon pad 501 is too hard and is not suitable for blocking the tone hole.

However, there is a problem that silicone material is difficult to effectively fix to the inner side of the key. This is because, when fixing to the inner side of the key, shellac or glue gun is usually used, but silicone material is difficult to fix with shellac or glue gun.

In order to enable fixation using shellac or glue, the pad 2 according to an embodiment of the present invention is proposed to further include a fixing pad 505. That is, the fixing pad 505 is a configuration for fixing the silicone pad 501 to the inner surface of the key.

The fixed pad 505 according to an embodiment of the present invention is proposed to be formed of a cork material. This is because the cork material is easy to combine with the silicone pad 501 through an adhesive layer (which may be formed by applying an adhesive or may include a thin layer on which an adhesive is applied), and at the same time, it is easy to fix the cork material to the inner side of the key using shellac or glue gun.

In addition, the elasticity of the cork material itself has the advantage of being able to assist the elasticity of the silicone material.

Furthermore, the cork material is quite effective in the structure of the pad 2 according to an embodiment of the present invention because the cork material can provide appropriate elasticity for easy bonding with the reflector 503 described below.

In general, the structure of the pad 2 is very important in controlling the tone of the wind instrument because the structure of the pad 2 is directly related to the resonance when covering the tone hole. Therefore, most players will be difficult to use the pad 2 if the tone of the wind instrument changes, no matter how much durability of the pad 2 made of silicon material improves. Therefore, in order to produce the same tone as the conventional leather-type pad even when using a silicone pad, one embodiment of the present invention proposes to additionally provide a reflector 503 formed of a predetermined material between the fixed pad 505 and the silicone pad 501.

In particular, the material of the reflector 503 according to one embodiment of the present invention is proposed.

In order to effectively fasten between the reflector 503, the silicon pad 501 and the fixed pad 505, one embodiment of the present invention proposes forming a first adhesive layer 502 between the silicon pad 501 and the reflector 503, and forming a second adhesive layer 504 between the reflector 503 and the fixed pad 505.

The pad 2 formed in this manner is resistant to changes in moisture due to the characteristics of own material of the pad 2, does not harden even after long-term use, and can be easily fixed to the inner surface of the key using shellac or glue gun due to the material of the fixed pad 505, so the pad 2 has the advantage of being easy to attach and detach.

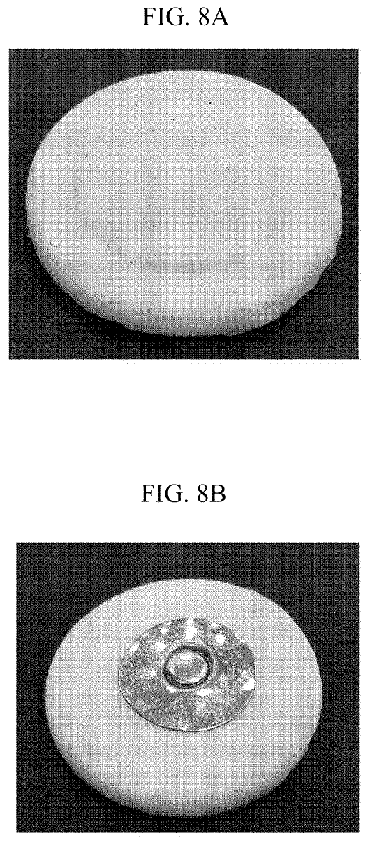

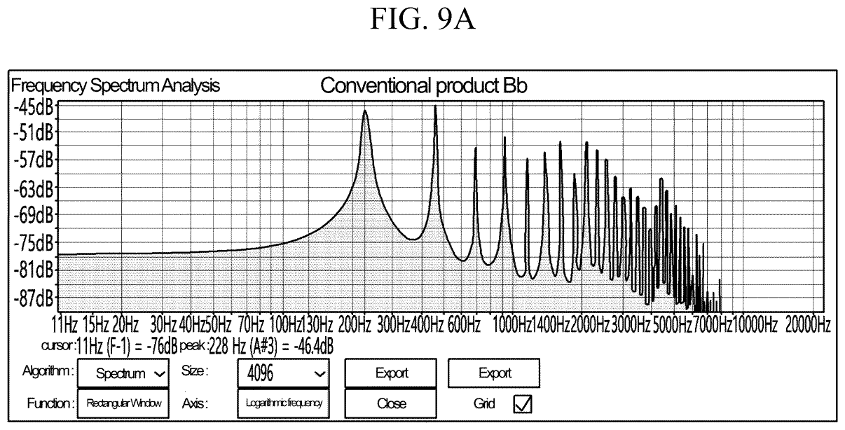

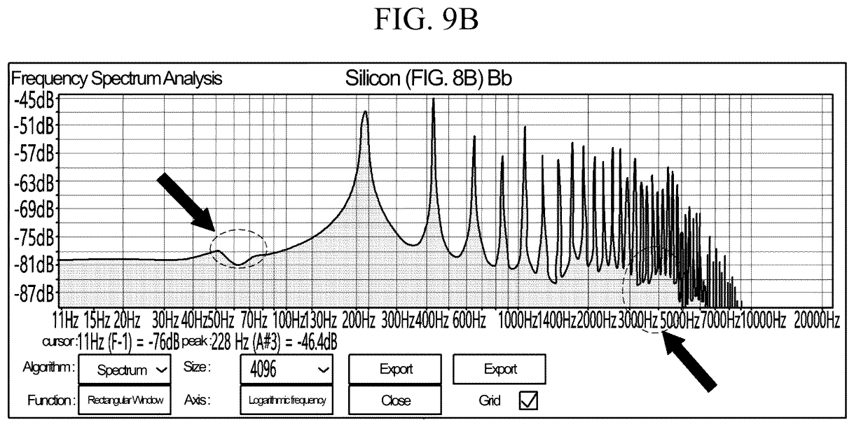

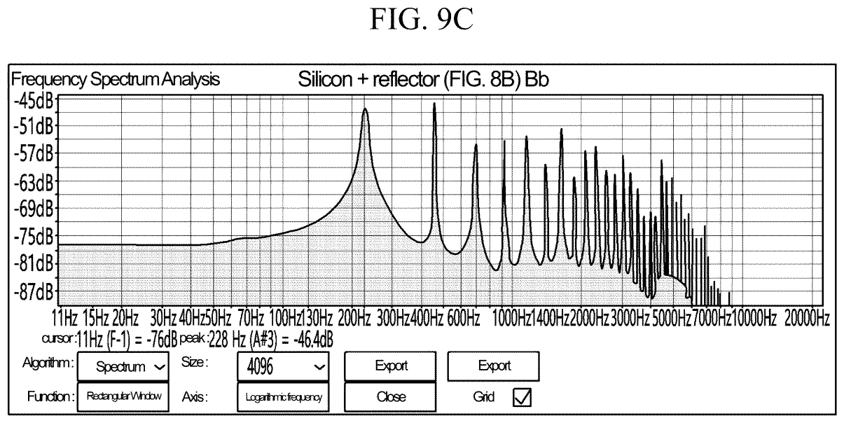

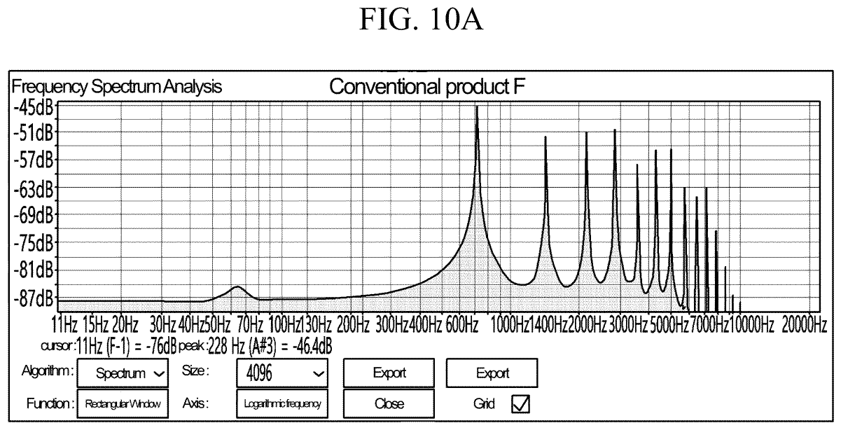

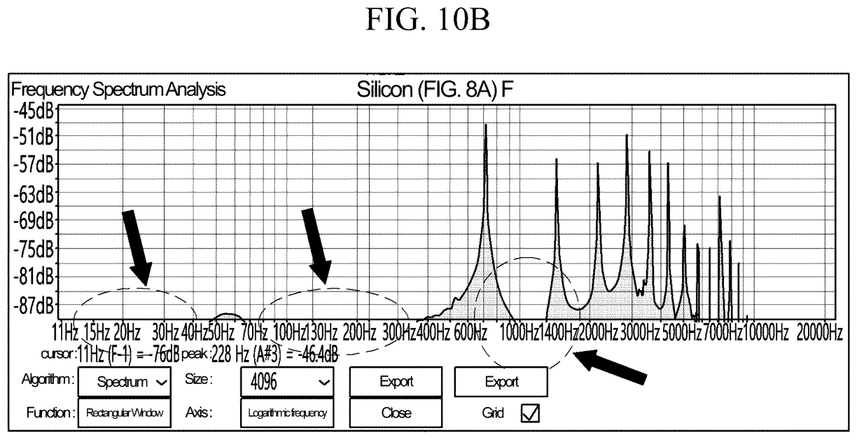

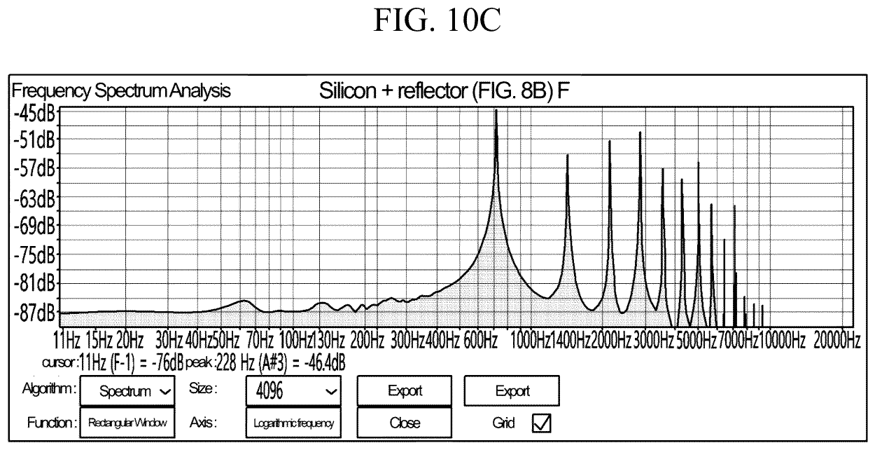

FIGS. 8A to 10C are drawings showing the frequency change of a saxophone when a conventional pad and a pad according to an embodiment of the present invention are applied.

The experiment was conducted by comparing the frequencies of the conventional pad, the case where a silicone pad was applied (FIG. 8A, without a reflector), and the case where a reflector was applied together with the silicone pad (FIG. 8B).

FIGS. 9A to 9C shows the frequency change that occurs when a pad is applied to a key corresponding to the “Bb” note among the saxophone keys and the corresponding note is played.

Referring to FIGS. 9A to 9C, it can be confirmed that there is a difference in frequency response (pointed by the red arrow) between the pad with only silicone applied (FIG. 9B) and the conventional pad (FIG. 9A). However, when a reflector is applied together with the silicone pad, it can be confirmed that the difference in FIG. 9B disappears.

FIGS. 10A to 10C shows the frequency change that occurs when a pad is applied to the key corresponding to the “F” note on the saxophone key and the corresponding note is played.

Referring to FIGS. 10A to 10C, it can be confirmed that there is a difference in frequency response (pointed by the red arrow) between the pad with only silicone applied (FIG. 10B) and the conventional pad (FIG. 10A). However, when a reflector is applied together with the silicone pad, it can be confirmed that the difference in FIG. 10B disappears.

That is, in light of the experimental results of FIGS. 9A to 10C, it can be seen that when the reflector is applied together with the silicone pad, a result almost similar to the frequency response of a conventional product can be obtained. On the other hand, since the silicone pad without the reflector shows a different frequency response from a conventional product, performers may feel discomfort due to the changed tone.

Hereinafter, embodiments of the pad for the wind instrument according to the present invention will be described, but this is only described as at least one embodiment, and the technical idea of the present invention and its configuration and operation are not limited thereby, and the scope of the technical idea of the present invention is not limited/restricted by the drawings or the description referring to the drawings. In addition, the concept and embodiment of the invention presented in the present invention may be used as a basis for modifying or designing another structure to perform the same purpose of the present invention by a person having ordinary skill in the technical field to which the present invention belongs, and an equivalent structure modified or changed by a person having ordinary skill in the technical field to which the present invention belongs is bound by the technical scope of the present invention described in the claims, and various changes, substitutions, and modifications are possible within the scope that does not depart from the spirit or scope of the invention described in the claims.

1. A pad for opening and closing a tone hole of a wind instrument by adhering to an upper main part of a tone hole tube, including:
a circular silicone pad adhering to the upper main part;
a fixing pad for fixing the circular silicone pad to an inner side of a key;
a reflector positioned between the circular silicone pad and the fixed pad; and
an adhesive layer for bonding the fixing pad and the circular silicone pad,
wherein the fixing pad is made of cork material,
wherein the circular silicone pad is made of silicone material with a shore hardness of 20 to 40,
wherein the adhesive layer includes a first and a second adhesive layers,
wherein the first adhesive layer is formed between the circular silicone pad and the reflector, and the second adhesive layer is formed between the reflector and the fixing pad, and
wherein the circular silicone pad has a hole in a center and a curved slope that becomes thinner from the center to the edge.

2. The pad of claim 1, wherein the circular silicone pad is a disc of silicone rubber with a thickness of about 1.0 to 1.5 mm.

3. The pad of claim 1, wherein a diameter of the fixing pad is smaller than a diameter of the circular silicone pad, the fixing pad has a disc shape.
